(19) United States
(12) Patent Application Publication
(10) Pub. No.: US 2017/0334423 A1
(43) Pub. Date: Nov. 23, 2017

(54) SYSTEM AND METHOD FOR POWERING A POWER CONSUMING VEHICLE ACCESSORY DURING AN OFF STATE OF THE VEHICLE

(71) Applicant: Ford Global Technologies, LLC, Dearborn, MI (US)

(72) Inventors: Kimberley King, Northville, MI (US); Bijal Patel, Northville, MI (US); Viet Quoc To, West Bloomfield, MI (US); Philip Michael Gonzales, Dearborn, MI (US); Josephine S. Lee, Novi, MI (US)

(21) Appl. No.: 15/476,206

(22) Filed: Mar. 31, 2017

Related U.S. Application Data
(63) Continuation of application No. 11/742,890, filed on May 1, 2007, now abandoned.

(51) Int. Cl. B60W 20/10; B60L 1/02; B60L 1/04; B60L 11/12; B60W 10/06; B60W 10/30; B60K 6/20; B60W 10/08; B60W 10/24; B60L 11/18; B60W 20/00

(52) U.S. Cl. CPC B60W 20/10; B60W 10/24; B60L 1/02; B60L 1/04; B60L 11/12; B60L 11/1862; B60W 10/06; B60W 10/30; B60K 6/20; B60W 10/08; B60W 20/00; B60W 2510/244; Y02T 10/7005; Y02T 10/7044; Y02T 10/705; Y02T 10/7077

(57) ABSTRACT

A hybrid battery system of an automotive vehicle provides power to various features without running an internal combustion engine.

### CROSS-REFERENCE TO RELATED APPLICATION

This application is a continuation of U.S. application Ser. No. 11/742,890, filed May 1, 2007, the disclosure of which is hereby incorporated in its entirety by reference herein.

### BACKGROUND

### 1. Field of the Invention

The invention relates to systems and methods for powering power consuming vehicle accessories during an off state of the vehicle.

2. Discussion

Prior to use, a vehicle may have an interior climate that is not preferred by a user. For example, the vehicle may be colder, e.g., cold soaked, or warmer, e.g., hot soaked, than desired. An internal combustion engine may be used to power climate control features to achieve a desired interior climate.

### SUMMARY

Embodiments of the invention may take the form of a system for powering a power consuming vehicle accessory. The system includes a power plant, a traction battery, and an electric motor to operatively couple the power plant and traction battery. The system also includes a traction battery controller connected with the traction battery to periodically monitor a state of charge of the traction battery and to enable the traction battery to power the power consuming vehicle accessory.

Embodiments of the invention may take the form of a method for powering a power consuming vehicle accessory. The method includes receiving a command signal to enable the traction battery to power the power consuming vehicle accessory, determining whether a current state of charge of the traction battery is greater than a predetermined state of charge, and enabling the traction battery to power the power consuming vehicle accessory.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a block diagram of a power system for features of a hybrid electric vehicle and shows a high voltage traction battery capable of being selectively electrically connected with an electric motor, a DC/DC power converter, and/or an electric heater via a set of switches.

FIG. 2A is a block diagram of a portion of the power system of FIG. 1 and shows the switches configured such that the high voltage traction battery is electrically connected with the motor/generator.

FIG. 2B is another block diagram of a portion of the power system of FIG. 1 and shows the switches configured such that the high voltage traction battery is electrically connected with the DC/DC power converter.

FIG. 2C is still another block diagram of a portion of the power system of FIG. 1 and shows the switches configured such that the high voltage traction battery is electrically connected with the electric heater.

FIG. 3 is a flow chart of a method for powering a feature during a vehicle off state in accordance with an embodiment of the invention.

FIG. 4 is a flow chart of a control strategy employed by a high voltage battery controller in accordance with an embodiment of the invention.

### DETAILED DESCRIPTION

Powering climate control features with a power plant, such as an internal combustion engine, may increase fuel consumption, emissions, and efficiency losses. Embodiments of the invention may use a battery system to provide power to various climate control features thereby minimizing fuel consumption, emissions, and efficiency losses.

Embodiments of the invention may use traction battery power for functions beyond vehicle propulsion. For example, seats may be cooled by activating an air conditioning system's compressor and fan. A DC/DC power converter may be powered with the traction battery to run a 12V accessory circuit to power an air pump. The air pump may be used to inflate various items including floats for swimming or an air mattress for camping. Flat tires may be inflated on site with the device as well.

Embodiments of the invention may power a DC/DC power converter with a traction battery to run an inverter supplying an external 110V outlet. The external outlet may be used for various functions including powering a television, mini-refrigerator, external radio, external CD player, or other tailgating accessories. Any other equipment requiring a 110V outlet could also be powered.

Embodiments of the invention may power a DC/DC power converter with a traction battery to support a 12V system for extended use. A vehicle may automatically institute auxiliary power for in vehicle accessories or a customer may choose to initiate auxiliary power for in vehicle accessories via an input into a battery controller. Extended use of 12V accessories may allow the customer to use an audio/video system for an extended period of time. It may also allow a customer to use headlights or hazard lights for an extended period of time.

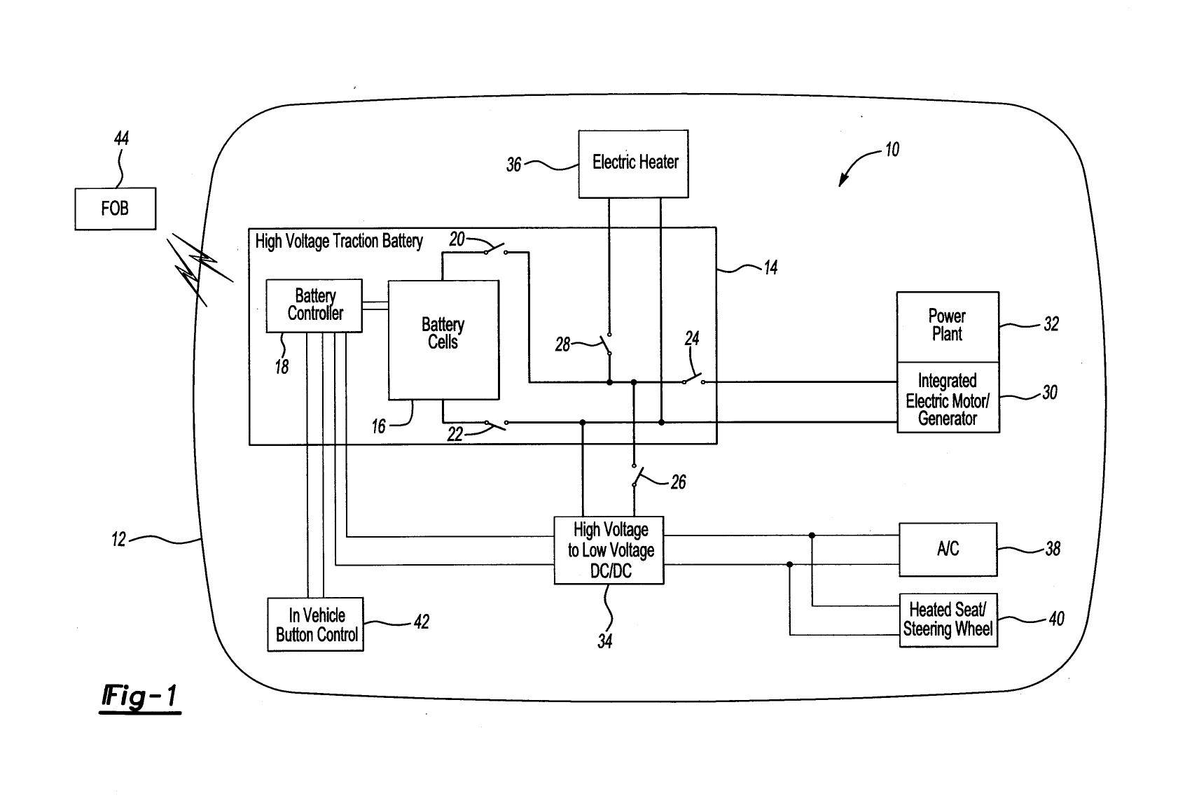

FIG. 1 is a block diagram of power system 10 of vehicle 12. Vehicle 12 has an on state, e.g., key on, and an off state, e.g., key off. Power system 10 includes high voltage traction battery 14. High voltage traction battery 14 includes battery cells 16, e.g., Nickel Metal Hydride (NiMH), Lithium Ion, battery controller 18, and switches 20, 22, 24, 26, 28. As explained below, high voltage traction battery 14 may be selectively electrically connected with motor/generator 30. High voltage traction battery 14 may also be selectively electrically connected with DC/DC power converter 34 and electric heater 36.

DC/DC power converter 34 is electrically connected with air conditioning compressor 38 and heated seat/heated steering wheel 40. In alternative embodiments, DC/DC power converter may be electrically connected with any number/type of loads, e.g., electric window defroster. Motor/generator 30 is coupled with power plant 32, e.g., engine, fuel cell. Engine 32 is configured, in typical fashion, to move vehicle 12 via a drivetrain.

Battery controller 18 controls switches 20, 22, 24, 26, 28, e.g., field effect transistors, contacts, etc. As such, high voltage traction battery 14 may be selectively electrically connected with motor/generator 30, electric heater 36, air conditioning blower 38 (via DC/DC power converter 34), and heated seat/heated steering wheel 40 (again, via DC/DC power converter 34). As shown in FIG. 1, switches 20, 22, 24, 26, 28 are open and thus high voltage traction battery 14 is not electrically connected with motor/generator 30, electric heater 36, air conditioning blower 38, or heated seat/heated steering wheel 40.

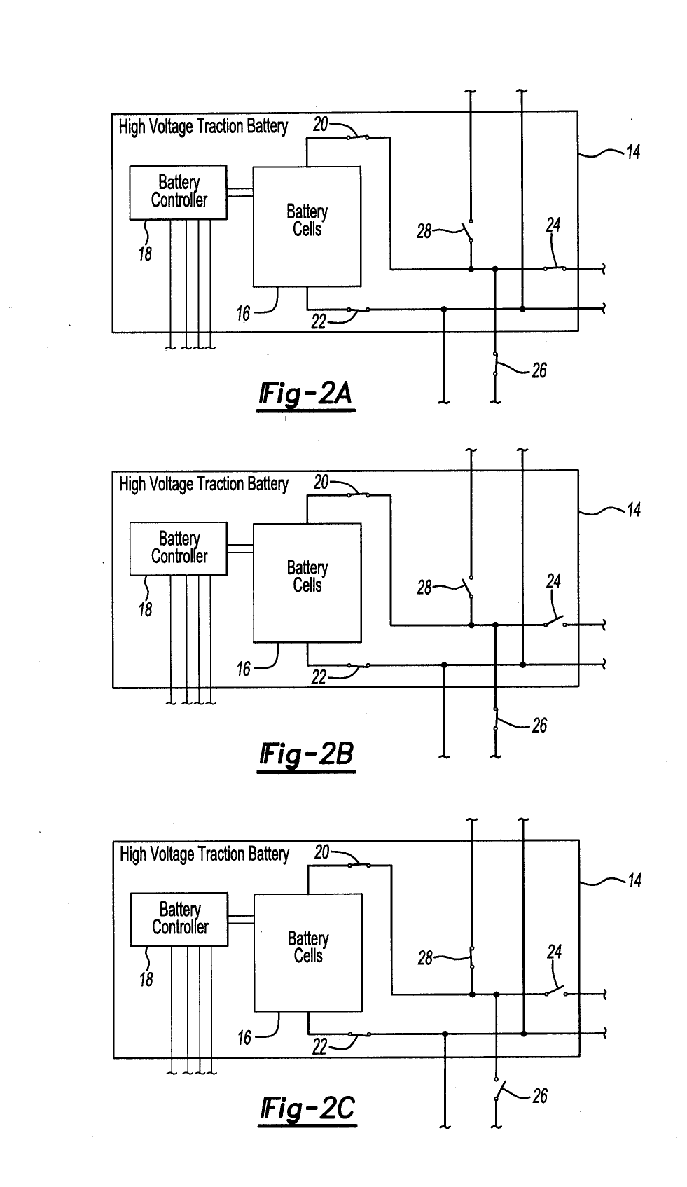

FIG. 2A is a block diagram of high voltage traction battery 14. If battery controller 18 is to electrically connect battery cells 16 and motor/generator 30, battery controller 18 closes switches 20, 22, 24, 26 by activating, for example, a solenoid internal to switches 20, 22, 24, 26.

FIG. 2B is another block diagram of high voltage traction battery 14. If battery controller 18 is to electrically connect battery cells 16 with air conditioning blower 38 and/or heated seat/heated steering wheel 40, battery controller 18 closes switches 20, 22, 26.

FIG. 2C is still another block diagram of high voltage traction battery 14. If battery controller 18 is to electrically connect battery cells 16 with electric heater 36, battery controller 18 closes switches 20, 22, 28.

As described above, because high voltage traction battery 14 may be electrically connected with electric heater 36, air conditioning blower 38, and/or heated seat/heated steering wheel 40 while not being electrically connected with motor/generator 30, high voltage traction battery 14 may be electrically connected with electric heater 36, air conditioning blower 38, and/or heated seat/heated steering wheel 40 while vehicle 12 is in its off state, e.g., key off

High voltage traction battery 14 is used to start engine 32 via motor/generator 30 by supplying high voltage power to motor/generator 30. As such, battery controller 18 determines whether battery cells 16 have sufficient state of charge, e.g., 20% for a NiMH battery at 25° C., to start engine 32 prior to, and while, providing any power to, for example, electric heater 36 and/or DC/DC power converter 34 if vehicle 12 is in its off state. Battery controller 18 thus periodically monitors the state of charge of battery cells 16. For example, every 20 minutes, the threshold state of charge necessary to start engine 32 is reevaluated based on the temperature and stand time of high voltage traction battery 14. As temperature decreases and/or stand time increases, the threshold state of charge may increase. Likewise, as temperature increases and/or stand time decreases, the threshold state of charge may decrease. Testing, at various temperatures and stand times, may be conducted to determine such threshold states of charge for a particular application. This ensures that the state of charge of battery cells 16 does not drop to a level such that engine 32 cannot be started. In alternative embodiments, battery controller 18 may continuously monitor the state of charge of battery cells 16.

If the state of charge of high voltage traction battery 14 drops below that which is necessary to start engine 32, battery controller 18 may disconnect battery cells 16 by removing, for example, power to solenoids associated with any of switches 20, 22, 26, 28 that are closed so as to preserve the power necessary to start engine 32.

Vehicle 12 includes input interface 42, e.g., buttons, dials, etc., which permit a user to select/activate vehicle climate control functions, e.g., air conditioning compressor, heating, even if engine 32 is off, e.g., vehicle 12 is in its off state. Battery controller responds to commands input via input interface 42 and operates switches 20, 22, 24, 26, 28 as described above to effectuate the desired climate control. Battery controller 18 also permits a user, via input interface 42, to preset, e.g., user selected, certain vehicle climate control functions such that they are activated after a designated period of time, e.g., seven hours. For example, battery controller 18 starts a real time clock feature and will count to the specified time. Once the specified time is reached, the function is enabled. The climate of vehicle 12 may thus be more favorable when the user later enters vehicle 12 for use.

Device 44, e.g., key fob, etc., may be used to transmit command signals to battery controller 18 for vehicle climate control functions if engine 32 is off, e.g., vehicle 12 is in its off state. The user of device 44 may issue a command signal by, for example, pressing a button which in turn prompts battery controller 18 to selectively close at least one of switches 20, 22, 26, 28 so that during the off state of vehicle 12 at least one of electric heater 36, air conditioning blower 38, and heated seat/heated steering wheel 40 are operable.

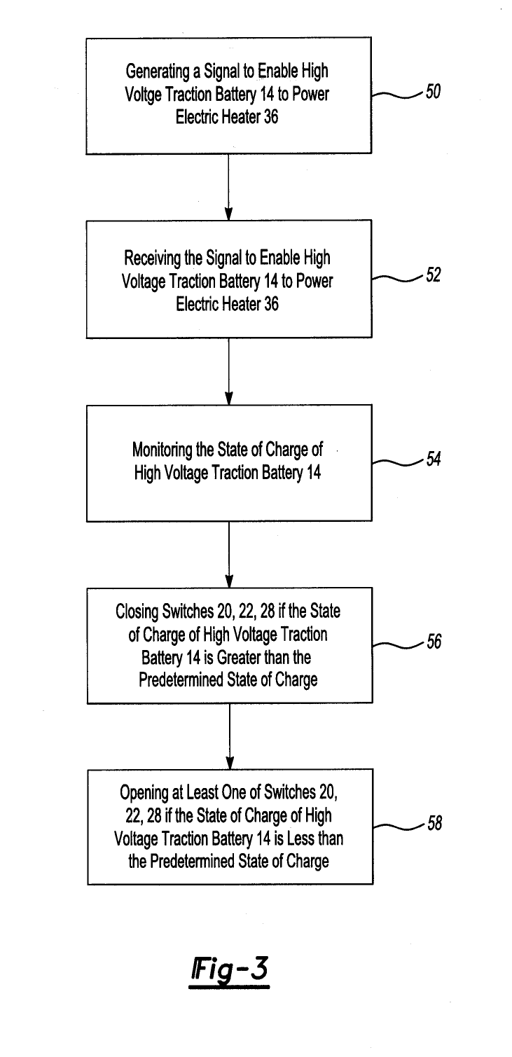

FIG. 3 is a flow chart of a method for powering a feature during a vehicle off state. At step 50, a signal to enable high voltage traction battery 14 to power electric heater 36 is generated. At 52, the signal to enable high voltage traction battery 14 to power electric heater 36 is received. At 54, the state of charge of high voltage traction battery 14 is monitored. At 56, switches 20, 22, 28 are closed if the state of charge of high voltage traction battery 14 is greater than a predetermined state of charge. At 58, at least one of switches 20, 22, 28 is opened if the state of charge of high voltage traction battery 14 is less than the predetermined state of charge.

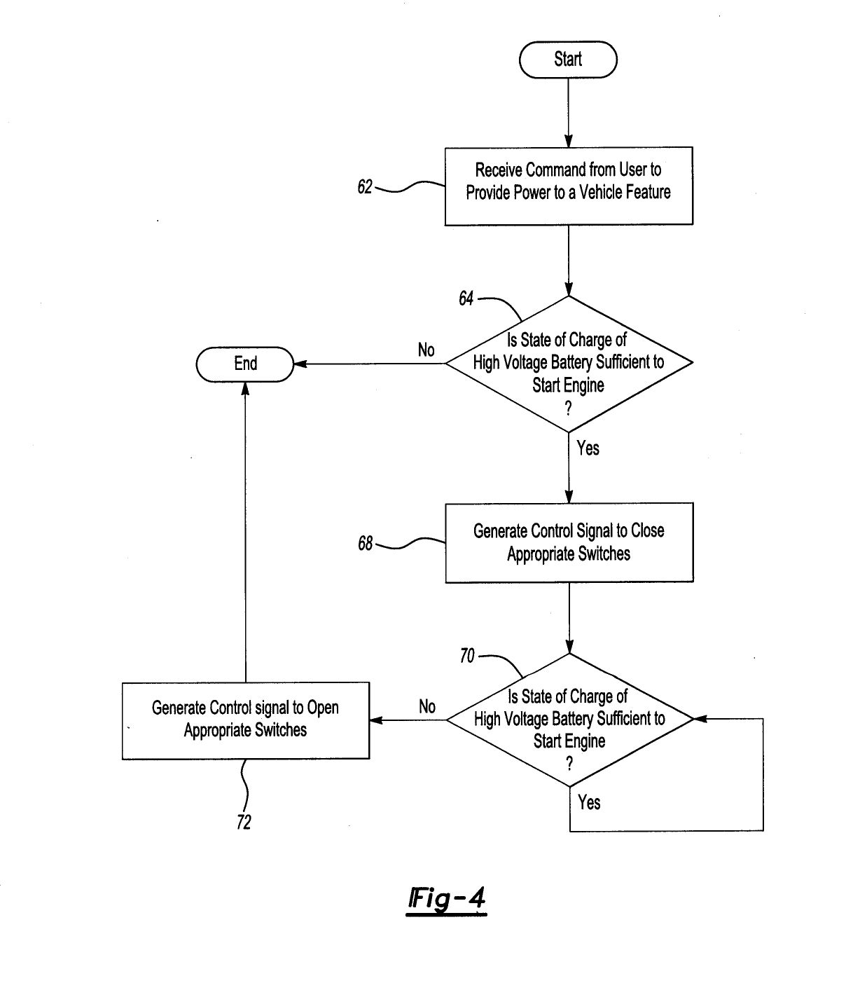

FIG. 4 is a flow chart of control strategy for a high voltage battery controller to provide power to one or more vehicle features. At 62, the controller receives a command to provide power to a vehicle feature. At 64, the controller determines whether the state of charge of a high voltage battery is sufficient to start an engine. If no, the controller does nothing. At 68, if yes, the controller generates a control signal to close the appropriate switches to enable the high voltage battery to power the one or more vehicle features. At 70, the controller determines whether the state of charge of the high voltage battery is sufficient to start the engine. At 72, if no, the controller generates a control signal to open the switches closed at 68. At 74, if yes, the controller loops back to 70.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1-20. (canceled)

21. A vehicle power system comprising:
an external 110V power outlet, an inverter, a DC/DC converter, and a traction battery operatively arranged with one another; and
a controller programmed to, responsive to a demand for power at the power outlet and a state of charge of the traction battery exceeding a threshold, command the traction battery to power the DC/DC converter to provide power to satisfy the demand via the inverter and power outlet.

22. The system of claim 21, wherein the controller is further programmed to alter the threshold based on a stand time associated with the traction battery.

23. The system of claim 22, wherein the threshold increases as the stand time increases.

24. The system of claim 21, wherein the controller is further programmed to alter the threshold based on a temperature of the traction battery.

25. The system of claim 24, wherein the threshold increases as the temperature decreases.

26. The system of claim 24, wherein the threshold decreases as the temperature increases.

27. A method for operating a power system of a vehicle, the method comprising:
by a controller,
responsive to a demand for power at an external 110V power outlet and a state of charge of a traction battery exceeding a threshold, commanding the traction battery to power a DC/DC converter to provide power to satisfy the demand via an inverter and the power outlet.

28. The method of claim 27 further comprising altering the threshold based on a stand time associated with the traction battery.

29. The method of claim 28 further comprising increasing the threshold as the stand time increases.

30. The method of claim 27 further comprising altering the threshold based on a temperature of the traction battery.

31. The method of claim 30 further comprising increasing the threshold as the temperature decreases.

32. The method of claim 30 further comprising decreasing the threshold as the temperature increases.
